(19) United States
(12) Patent Application Publication
(10) Pub. No.: US 2013/0146150 A1
(43) Pub. Date: Jun. 13, 2013

(54) MULTI-SEAT FLUID CONTROL SYSTEM

(71) Applicant: Amrish Chopra, Faridabad (IN)

(72) Inventor: Amrish Chopra, Faridabad (IN)

(21) Appl. No.: 13/761,726

(22) Filed: Feb. 7, 2013

Related U.S. Application Data
(63) Continuation-in-part of application No. PCT/IN2010/000764, filed on Nov. 25, 2010.

(30) Foreign Application Priority Data
Aug. 11, 2010 (IN) 1881/DEL/2010

(51) Int. Cl. G05D 16/10

(52) U.S. Cl. CPC G05D 16/106
USPC 137/87.04

(57) ABSTRACT

The present subject matter relates to a fluid control system having a first orifice to provide a first pass-area to a fluid, a first closing element to vary the first pass-area, a second orifice, smaller than the first orifice and configured in the first closing element, to provide a second pass-area to the fluid, a second closing element to vary the second pass-area, a single actuating shaft and a balancing chamber. The first closing element includes a channel The fluid flows through the channel to and from the balancing chamber for equalizing of fluid pressure across the first closing element. The first and the second pass-areas are varied by the first and the second closing elements through movements of the actuating shaft. Further, the first and the second closing elements are contoured in the direction of movement of the shaft to vary the first and the second pass-areas.

### CLAIM OF PRIORITY

This application is a continuation-in-part under 35 U.S.C. 111(a) and claims the benefit of priority under 35 U.S.C. § 365(c) and in accordance with 35 U.S.C. § 120 to International Patent Application Serial No. PCT/IN2010/000764, filed on Nov. 25, 2010, and published in English on Feb. 16, 2012, as WO 2012/020419 A1, which claims the benefit under 35 U.S.C. 119 to Indian Application Serial No. 1881/DEL/2010, filed on Aug. 11, 2010, the benefit of priority of each of which is claimed hereby, and each of which are incorporated by reference herein in its entirety.

### TECHNICAL FIELD

The present subject matter relates to a fluid control system, particularly a multi-seat fluid control system, installed in a flow path of a fluid.

### BACKGROUND

Fluid control systems are installed with at least one valve, commonly called a control valve, in a flow path of the fluid for regulating flow of fluids in systems implemented in industrial and commercial applications. The regulation of the flow of fluids enables regulation or control of various fluid parameters, for example fluid flow rate, fluid pressure, and/or fluid temperature. The parameters are regulated by controlling opening and/or closing the control valve, and in turn controlling a pass-area for the fluid to flow through the control valve. The opening and closing of the control valve are controlled manually or through the dictates of a controller. Depending upon the requirement of fluid parameter(s), the control valve is actuated to vary the pass-area for the fluid to flow through the control valve.

A conventional plug-type control valve, installed in a flow path of a fluid, is in the form of a casing (or valve casing) with an inlet and an outlet for the fluid. The casing includes a valve seat with an orifice, through which the fluid is allowed to pass from the inlet to the outlet. A pressure difference between the inlet and the outlet causes the fluid to flow. The valve casing further includes a plug that opens or closes the orifice. To close the orifice the plug is moved in the orifice and seated on the valve seat, and to open the orifice the plug is lifted off from the valve seat. The plug for its movements (or strokes), is connected to a shaft, which is actuated by an actuator. The actuation of the shaft can be automated or manual and based on an electrical, a pneumatic, or a hydraulic system. The movements or strokes of the plug, in or out of the orifice, vary the pass-area of the orifice offered to the fluid passing through the valve. This varying pass-area dictates the resistance observed by the fluid in passing through the control valve, and the observed resistance in turn dictates the flow rate of the fluid through the control valve. The desired flow rate is achieved by regulating the pass-area of the orifice by controlling the movement and position of the plug. A maximum flow rate is achieved with fully open orifice offering maximum pass-area to the fluid, and a minimum or zero flow rate is achieved with fully closed orifice offering minimum or null pass-area to the fluid.

However, in the conventional control valves, there is a significant amount of clearance between the orifice seat and the plug, to allow for reasonable machining tolerance and to permit free movement of the plug under varying temperatures and fluid pressures (operating conditions). This clearance generally depends on the size of the orifice. The larger the orifice the larger is the clearance. The clearance limits the minimum flow regulating capability of the conventional control valves. Valve may be fully closed when the plug is seated on the seat but even a little effort to open the plug results in sudden opening of the clearance area and respective increase in flow rate. Thus, the conventional control valves are said to operate in ON/OFF mode near the closing position of the control valve. In other words, the conventional valves are capable of achieving either zero or above a certain minimum fluid flow rate.

Further, the conventional control valves have low rangeability. Rangeability is defined as the ratio of maximum to minimum controllable flow rate of the control valve at constant pressure drop across the control valve. Rangeability also defines the range of flow rates over which the control valve has effective control. At constant pressure drop across the control valve, the rangeability is assumed to be directly proportional to the maximum orifice pass- area and inversely proportional to the minimum clearance between the orifice seat and the plug. With a significantly large minimum clearance, the conventional control valves offer poor rangeability.

Further, in the conventional control valves, in installed state, the pressure drop across the valve does not remain constant, rather the pressure drop increases as the control valve is closed and approaches the closed state. This increase in the pressure drop increases the flow rate of the fluid flowing through the minimum orifice pass-area, thus reducing the controllable flow rate range of the control valve.

Further, in the conventional control valves, when the control valve is about to close and the pressure across the valve is maximum, the fluid is forced through a small clearance between the orifice and the plug resulting in a high noise due to high fluid velocities, excessive wear of the orifice and the plug surfaces due to high fluid velocities, and erosion of control surfaces due to vaporization and formation of gas bubbles.

Further, conventional fluid control systems have been configured with two or more separate control valves of difference size and capacities, in order to improve minimum flow control capabilities and rangeability. However, in these systems, the mechanics is more involved, complex and cumbersome, and initial cost of the valves and the cost of operation are high.

### SUMMARY

The subject matter disclosed herein describes a fluid control system installed in a flow path of a fluid. The fluid control system includes a first orifice to provide a first pass-area to the fluid, a first closing element to vary the first pass-area, a second orifice, configured in the first closing element, to provide a second pass-area to the fluid, a second closing element to vary the second pass-area, a single actuating shaft and a balancing chamber. The second orifice is smaller than the first orifice. The first closing element includes a channel between bottom end of the first closing element and top end of the first closing element. The fluid flows through the channel to and from the balancing chamber for equalizing of fluid pressure across the first closing element. The first orifice includes a first seat for the first closing element to rest and close the first orifice, and the second orifice includes a second seat for the second closing element to rest and close the second orifice. The first pass-area and the second pass-area are varied by the first closing element and the second closing element through movements of the single actuating shaft. Further, the first closing element and the second closing element are contoured in the direction of movement of the actuating shaft to vary the first pass-area and the second pass-area.

These and other features, aspects, and advantages of the present subject matter will become better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE DRAWINGS

The novel features of the subject matter are set forth in the appended claims hereto. The subject matter itself, however, as well as a preferred mode of use, further objectives, and advantages thereof, will best be understood by reference to the following detailed description of illustrative embodiments when read in conjunction with the accompanying drawings, wherein the same numbers are used throughout the drawings to reference like features, and wherein:

FIG. 1 illustrates a sectional view of a conventional plug type control valve.

FIGS. 2a and 2b illustrate a position of a plug and corresponding orifice pass-area in the conventional control valve.

FIGS. 3a and 3b illustrate another position of the plug and corresponding orifice pass-area in the conventional control valve.

FIGS. 4a and 4b illustrate another position of the plug and corresponding orifice pass-area in the conventional control valve.

FIG. 5 illustrates a sectional view of a fluid control system, according to an embodiment of the present subject matter.

FIGS. 6a and 6b illustrate positions of closing elements and corresponding orifice pass-areas in the fluid control system, according to an embodiment of the present subject matter.

FIGS. 7a and 7b illustrate other positions of closing elements and corresponding orifice pass-areas in the fluid control system, according to an embodiment of the present subject matter.

FIGS. 8a and 8b illustrate other positions of closing elements and corresponding orifice pass-areas in the fluid control system, according to an embodiment of the present subject matter.

FIGS. 9a and 9b illustrate other positions of closing elements and corresponding orifice pass-areas in the fluid control system, according to an embodiment of the present subject matter.

FIG. 10 illustrates a sectional view of a fluid control system, according to another embodiment of the present subject matter.

FIG. 11 illustrates a sectional view of a fluid control system, according to another embodiment of the present subject matter.

### DETAILED DESCRIPTION

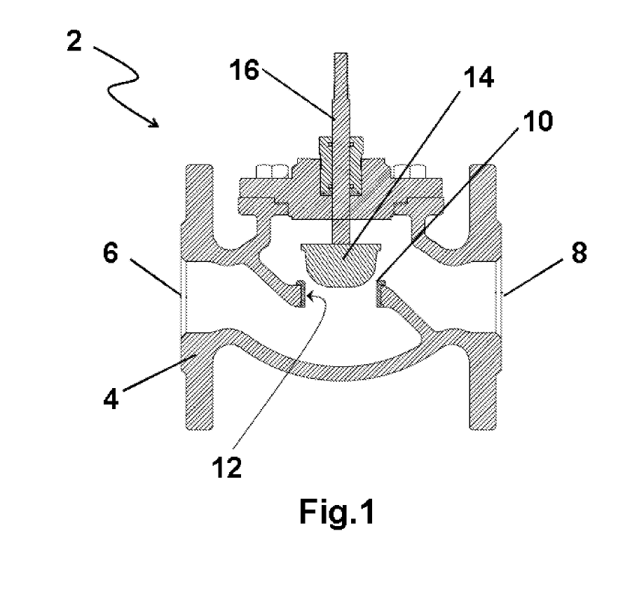

FIG. 1 shows a sectional view of a conventional plug-type control valve 2 of a fluid control system that is installed in a flow path of a fluid to regulate flow of the fluid. The conventional control valve 2 is in the form of a casing 4 (or valve casing 4) with an inlet 6 and an outlet 8 for the fluid. The casing 4 includes a valve seat 10 with an orifice 12, through which the fluid from the inlet 6 to the outlet 8 is allowed to pass. A pressure difference between the inlet 6 and the outlet 8 causes the fluid to flow. The valve casing 4 further includes a plug 14 that opens or closes the orifice 12. To close the orifice 12 the plug 14 is moved in the orifice 12 and seated on the valve seat 10, and to open the orifice 12 the plug 14 is lifted off from the valve seat 10. The plug 14 for its movements (or strokes) is connected to a shaft 16, which is actuated by an actuator (not shown). The actuation of the shaft 16 can be automated or manual and based on an electrical, a pneumatic, or a hydraulic system.

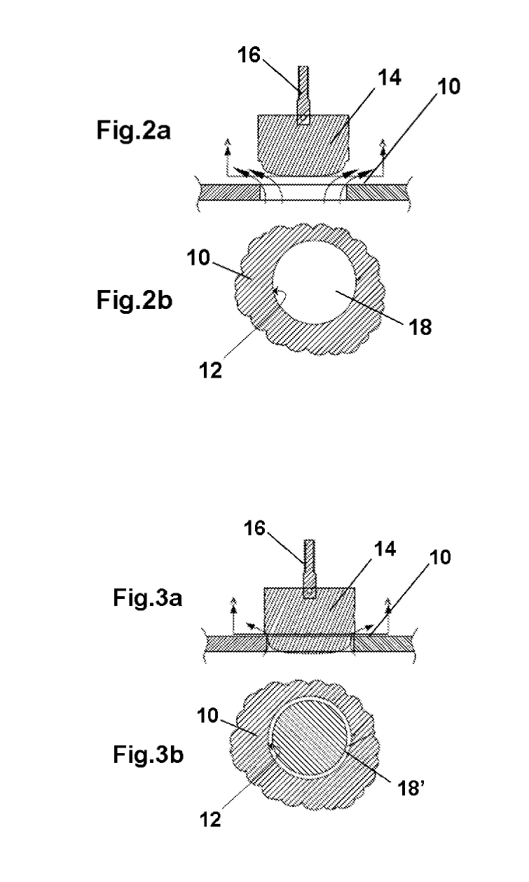

FIGS. 2a, 2b, 3a, 3b, 4a and 4b show various positions of the plug 14 and corresponding orifice pass-areas 18, 18′ in the conventional control valve 2. FIGS. 2b, 3b and 4b represent views of FIGS. 2a, 3a and 4a, respectively, in direction A-A. The movements or strokes of the plug 14, in or out of the orifice 12, vary the pass-area of the orifice 12 offered to the fluid passing through the control valve 2.

In FIG. 2a, the plug 14 is away from the valve seat 10. At this, the orifice 12 is open and a maximum pass-area 18 is offered by the orifice 12 to the fluid, as shown in FIG. 2b. For this position of the plug 14, the control valve 2 is said to be in an open state (or fully open state).

In FIG. 3a, the plug 14 is close to the valve seat 10, in a slightly lifted-off position. At this, a partial pass-area (or clearance area) 18′ is offered by the orifice 12 to the fluid, as shown in FIG. 3b. For this position of the plug 14, the control valve 2 is said to be in a partial open (or just-opening) state. This pass-area 18′ represents the minimum pass-area.

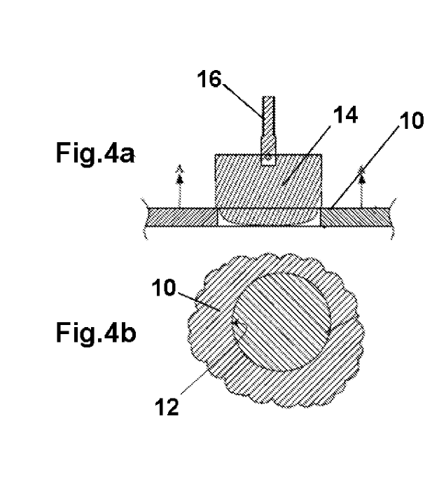

In FIG. 4a, the plug 14 is seated on the valve seat 10. At this, the orifice 12 is closed and a null pass-area is offered by the orifice 12 to the fluid, as shown in FIG. 4b. For this position of the plug 14, the control valve 2 is said to be in a close state (or fully close state).

These varying pass-areas 18, 18′, from maximum to null, dictate the resistance observed by the fluid in passing through the control valve 2. The observed resistance in turn dictates the flow rate of the fluid through the control valve 2. The desired flow rate is achieved by regulating the pass-area of the orifice 12 by controlling the movement and position of the plug 14. A maximum flow rate is achieved with the fully open orifice 12 offering the maximum pass-area 18 to the fluid, and a zero flow rate is achieved with the fully closed orifice offering the null pass-area to the fluid.

However, the minimum flow regulating capability of the conventional control valves 2 is limited. The conventional control valves 2 are said to operate in ON/OFF mode near the closing position of the control valve due to a significant amount of clearance present between the orifice seat 10 and the plug 14, as described earlier. In other words, the conventional valves 2 are capable of achieving either zero or above a certain minimum fluid flow rate. Further, with a significantly large minimum clearance, the conventional control valves 2 offer poor (low) rangeability. This further elucidates that the conventional control valves 2 have control over a limited range of fluid flow rates. Particularly, near the low flow rates, the conventional control valves 2 offer a narrow range of controllable flow rates, in which the flow rate goes from a certain minimum flow rate to zero.

In order to improve minimum flow control capabilities and rangeability, conventional fluid control systems have been configured with two or more separate control valves of difference size and capacities. However, in these conventional systems, the mechanics is more involved, complex and cumbersome, and initial cost of the valves and the cost of operation are high.

Further, in the conventional control valve 2, shown in FIG. 1, the fluid imparts a fluid pressure force on the plug 14. This force varies due to fluid pressure variations in the control valve 2. The fluid pressure variations are typically due to the design of the fluid control system in which the control valve 2 is installed or due to pressure transients present therein. The fluid pressure force in the control valve 2 affects the force required to operate the plug 14. Also, when the fluid pressure force is momentarily more than the force holding the plug 14, for example, in a closed position, it typically has a tendency to push the plug 14 away from the orifice seat 10 for that duration, thereby causing an undesirable opening of the control valve 2.

Thus, there is a need of a fluid control system or a control valve for industrial and commercial application, suitable for a wide range of flow rates (both high and low) with a substantially high rangeability and an improved minimum flow regulating capabilities with substantially no affect of fluid pressure variations or pressure transients on the force required to operate the control valve, where the control valve is simple in construction, simple to manufacture and operate, economical and have long working life.

The present subject matter relates to a fluid control system, particularly a multi-seat fluid control system, installed in a flow path of a fluid to regulate the flow of the fluid. The fluid control system, according to the present subject matter, includes at least two orifices for the fluid flowing through the control system. The at least two orifices are of different sizes and operate in parallel with each other, i.e. the biggest orifice closes first and opens last and the smallest orifice closes last and opens first. Further, the fluid control system includes a respective closing element for each orifice. This fluid control system advantageously has increased rangeability and substantially improved minimum flow regulation capabilities. With this fluid control system, a higher controllability range of fluid flow rates, both from high flow rates to low flow rates, is possible to achieve. In particular, with the fluid control system, according to the present subject matter, a better (wider) controllability range of fluid flow rates close to the substantially low flow rates is possible to achieve. Also, the construction and operation of the advantageous control system, according to the present subject matter, is simple and easy.

With this fluid control system the maximum flow rate depends on the size of the largest orifice and the minimum flow rate depends on the clearance between the smallest orifice and its corresponding closing element. Smaller the size of the orifice, smaller is the clearance due tighter machining tolerances possible and less effect of temperature and pressure variations. This arrangement effectively increases rangeability manifold.

For the sake of simplicity, in the specification, the fluid control system is described with two orifices, one smaller than the other, operating in parallel. However, the description can be extended to a fluid control system, according to another embodiment, configured with more than two orifices of different sizes and having the same working principle of orifices operating in parallel, as described above.

The fluid control system, according to an embodiment of the present subject matter, is in the form of a housing or a casing that includes a first orifice to provide a first pass-area to the fluid, a first closing element to vary the first pass-area, a second orifice, configured in the first closing element, to provide a second pass-area to the fluid, and a second closing element to vary the second pass-area. In the fluid control system, the second orifice is smaller than the first orifice. Further, the first orifice includes a first seat for the first closing element to rest and close the first orifice, and the second orifice includes a second seat for the second closing element to rest and close the second orifice. Further, the first pass-area and the second pass-area are varied by the first closing element and the second closing element through movements of an actuating shaft of the control system. The movements of the shaft relatively move the first closing element with respect to the first orifice and the second closing element with respect to the second orifice.

Further, in the fluid control system of the present subject matter, the first closing element includes a channel between the top end of the first closing element and the bottom end of the first closing element. The channel passes within the first closing element, from the bottom end to the top end of the first closing element. The channel hydraulically connects the bottom end and the top end of the first closing element. With this channel, the fluid pressure on the bottom end and the top end across the first closing element becomes substantially equal. Hence, the pressure force, imparted by the fluid, on the first closing element gets nullified. With this equalization of fluid pressure on both the ends of the first closing element, the force required to operate the first closing element remains unchanged, irrespective of any fluid pressure variation or pressure transients. The equalization of fluid pressure also substantially eliminates any undesirable movement of the first closing element, which may cause an opening of the first orifice, due to the fluid pressure force.

Further, the fluid control system includes a balancing chamber configured at, or in the proximity of, the second end of the first closing element. The fluid flowing in the fluid control system flows through the channel to and from the balancing chamber. With the filling of the fluid in the balancing chamber, the balancing chamber is maintained at a fluid pressure substantially same as the fluid pressure in the system. Thus, the balancing chamber and the channel facilitate in equalizing the fluid pressure at the top end and the bottom end of the first closing element, and hence across the first closing element.

In the preferred embodiment, the fluid is conveyed through the fluid control system via a single inlet and a single outlet.

In the preferred embodiment, the actuating shaft is a single shaft.

In the preferred embodiment, the first closing element and the second closing element are plugs that seat at the first orifice and the second orifice, respectively, and respectively vary the first and the second pass-areas.

Further, in the preferred embodiment of the fluid control system, the actuating shaft has a closing movement that reduces and subsequently closes the first pass-area and the second pass-area. In the closing movement, the actuating shaft moves in a first predefined direction to reduce and close the first pass-area before reducing and closing the second pass-area.

Further, in the preferred embodiment of the fluid control system, the actuating shaft has an opening movement that opens and subsequently increases the first pass-area and the second pass-area. In the opening movement, the actuating shaft moves in a second predefined direction to open and increase the second pass-area before opening and increasing the first pass-area.

Further, in the preferred embodiment of the fluid control system, the actuating shaft moves in the first predefine direction to close the first orifice by relatively moving the first closing element and the first orifice towards each other and resting the first closing element at the first seat, before closing the second orifice by relatively moving the second closing element and the second orifice towards each other and resting the second closing element at the second seat.

Further, in the preferred embodiment of the fluid control system, the actuating shaft moves in the second predefine direction to open the second orifice by relatively moving the second closing element and the second orifice away from each other, before opening the first orifice by relatively moving the first closing element and the first orifice away from each other. In this, the second closing element relatively moves away from the second seat, and the first closing element relatively moves away from the first seat.

Further, in the preferred embodiment of the fluid control system, the fluid flows through both the first orifice and the second orifice for achieving a substantially high flow rate, and the fluid flows only through the second orifice for achieving a substantially low flow rate.

Further, in the preferred embodiment of the fluid control system, the first orifice and the second orifice are of a closed perimeter shape. The closed perimeter shape is a shape where the periphery of the first orifice and the second orifice is continuous and is of a closed shape, like a circle, square, triangle, etc.

As mentioned earlier, the fluid flow is controlled through the orifices by increasing and decreasing the respective pass-areas. With the closed perimeter shape, the entire periphery of each of the orifices plays an active role in controlling the fluid flow, and the flow of fluid takes place along the direction of the movement of the first closing element and the second closing element.

Further, in the preferred embodiment of the fluid control system, the first closing element and the second closing element are contoured in the direction of movement of the actuating shaft. The contouring of the closing elements means the area of cross-section of the closing element progressively changes along the direction of movement. The progressive change is uniform and gradual. The contouring provides surface profiles to the closing elements, which facilitates progressive, i.e., gradual and uniform, variations in the pass-areas of the orifices, instead of abrupt variations, upon the movements of the closing elements. The gradual and uniform variations are understood as controlled variations of the pass-areas of the orifices while the contoured closing elements move inside the orifices.

In an embodiment, a portion of the first closing element, which is movable inside the first orifice, is contoured. The portion that moves inside the first orifice is contoured uniformly over its entire surface. Such contouring enables in achieving controlled variations of the first pass-area throughout the movement of the portion of the first closing element inside the first orifice.

Similarly, in an embodiment, a portion of the second closing element, which is movable inside the second orifice, is contoured. The portion that moves inside the second orifice is contoured uniformly over its entire surface. Such contouring enables in achieving controlled variations of the second pass-area throughout the movement of the portion of the second closing element inside the second orifice.

Further, in an embodiment, the first closing element has a stroke length substantially equal to the height of the portion of the first closing element, contoured and movable inside the first orifice. The stroke length is the distance travelled by the closing element, along the direction of movement of the actuating shaft, for opening or closing the orifice. With the stroke length equal to the height of the contoured portion, the first pass-area progressively changes throughout the entire stroke of the first closing element. The first pass-area is minimum at one end of the stroke and maximum at the other end of the stroke.

Similarly, in an embodiment, the second closing element has a stroke length substantially equal to the height of the portion of the second closing element, contoured and movable inside the second orifice. With this, the second pass-area progressively changes throughout the entire stroke of the second closing element. The second pass-area is minimum at one end of the stroke and maximum at the other end of the stroke.

Further, in an embodiment, the first orifice and the second orifice comprise surface profiles contoured in the direction of movement of the actuating shaft. The contoured surface profiles of the orifices enable gradual increase and/or decrease of the pass-areas of the orifices upon the relative movements of the closing elements with respect to the orifices.

Further, in the preferred embodiment of the fluid control system, the first closing element is shaped, at least at one section, so as to completely close the first orifice, and the second closing element is shaped, at least at one section, so as to completely close the second orifice.

Further, in the preferred embodiment, the movements of the shaft and the movements of the first closing element and the second closing element are linear movements.

Further, in an embodiment, the movements of the shaft and the movements of the first closing element and the second closing element may be rotary movements.

Further, in an embodiment, the movements of the shaft and the movements of the first closing element and the second closing element may be in any combination of linear and rotary movements.

The present subject matter is by no means restricted to the fluid control system with two orifices and two closing elements. The characteristic features of the fluid control system described for two orifice and two closing elements can be equally extended to a fluid control system with a plurality of orifices with a seat each and a plurality of closing elements to rest at the seats.

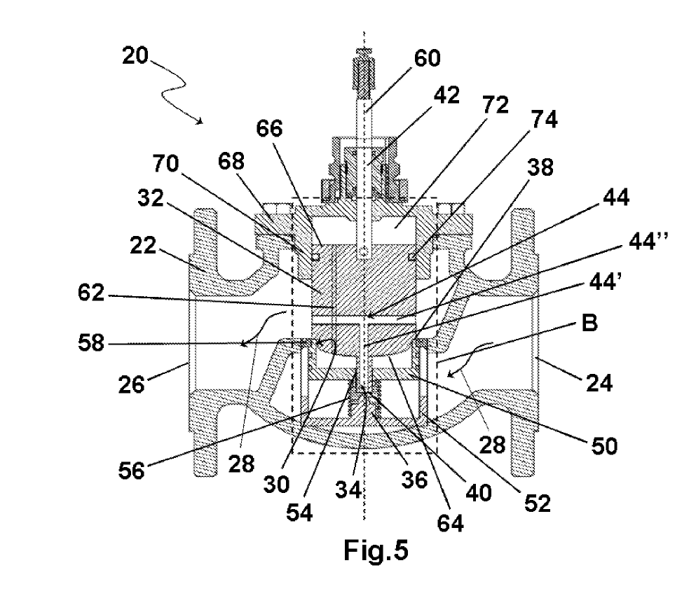

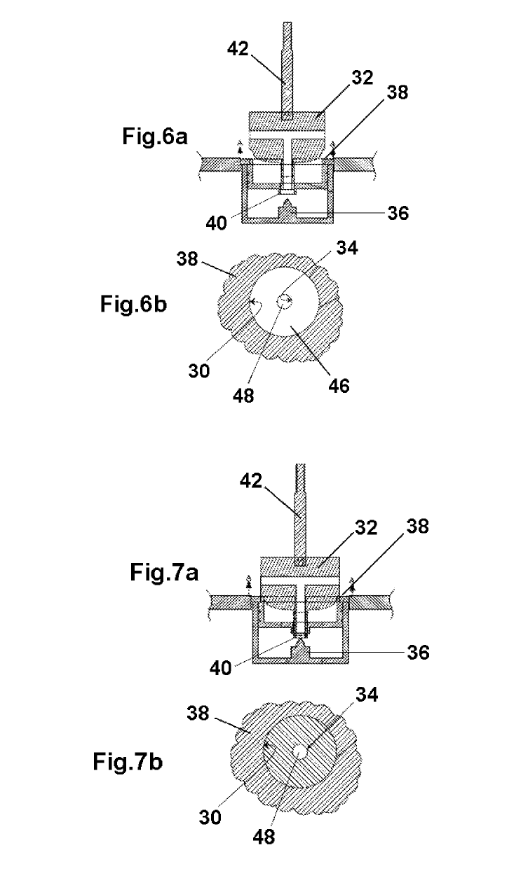

FIG. 5 illustrates a sectional view of the fluid control system 20, according to a preferred embodiment of the present subject matter. The fluid control system 20 is installed in a flow path of a fluid to regulate the flow of the fluid. The fluid control system 20 is in the form of a valve casing 22 with an inlet 24 and an outlet 26 for the fluid. A pressure difference between the inlet 24 and the outlet 26 causes the flow of fluid through the control system 20. In a flow path 28 of the fluid within the control system 20 between the inlet 24 and the outlet 26, the control system 20 includes a first orifice 30, a first closing element 32, a second orifice 34 and a second closing element 36. The first orifice 30 provides a first pass-area (shown in FIG. 6b) to the fluid and the first closing element 32 varies or controls the first pass-area. The second orifice 34 provides a second pass-area (shown in FIG. 6b) to the fluid and the second closing element 36 varies or controls the second pass-area. Further, the second orifice 34 is configured in the first closing element 32, as shown in FIG. 5. Also, the second orifice 34 and hence the second pass-area are smaller than the first orifice 30 and the first pass-area.

Further, in the control system 20, as shown in FIG. 5, a first seat 38 is formed on an edge of the first orifice 30 for the first closing element 32 to rest and close the first orifice 30, and a second seat 40 is formed on an edge of the second orifice 34 for the second closing element 36 to rest and close the second orifice 34.

Further, in the control system 20, an actuating shaft 42 (or simply a shaft 42 hereinafter) is provided that relatively actuates or relatively moves the first closing element 32 and the second closing element 36 with respect to the first orifice 30 and the second orifice 36, respectively. Movements of the shaft 42 vary the first pass-area of the first orifice 30 and vary the second pass-area of the second orifice 34.

Further, in the first closing element 32, a passage 44 is provided to convey the fluid from the inlet 24 to the outlet 26 via the second orifice 34, as shown in FIG. 5.

In an embodiment, the passage 44 includes a longitudinal channel 44′ in the first closing element 32 starting from the second orifice 34. The longitudinal channel 44′ extends into at least one radial channel 44″ terminating at an outer surface of the first closing element 32. The at least one radial channel 44″ lies in the proximity of a part of the flow path 28 leading to the outlet 26. In an embodiment, the passage 44 could be configured to provide necessary resistance to fluid flow at low flow rates in high differential pressure applications to prevent noise and erosion due to high flow velocities.

In the preferred embodiment, the shaft 42 is connected to the first closing element 32, as shown in FIG. 5.

In the preferred embodiment, the actuating shaft 42 is a single shaft.

FIGS. 6a, 6b, 7a, 7b, 8a, 8b, 9a and 9b show various positions of the first closing element 32 and the second closing element 36, and corresponding orifice pass-areas 46, 48, 48′ in the fluid control system, according to an embodiment of the present subject matter. FIGS. 6a, 7a, 8a and 9a represent section B (shown by dashed box) of FIG. 5, and FIGS. 6b, 7b, 8b and 9b represent views of FIGS. 6a, 7a, 8a and 9a, respectively, in direction A-A.

In FIG. 6a, the first closing element 32 is away from the first seat 38 of the first orifice 30 and the second closing element 36 is away from the second seat 40 of the second orifice 34. At this, the first orifice 30 and the smaller second orifice 34 are open and a maximum first pass-area 46 and a maximum second pass-area 48 are offered to the fluid by the respective orifices 30 and 34, as shown in FIG. 6b. For this position, the control system 20 is said to be in an open state (or fully open state) and a substantially high fluid flow rate is possible to achieve.

From the open state, the shaft 42 moves in a first predefined direction that at first moves the first closing element 32 towards the first orifice 30. This movement initially reduces the first pass-area of the first orifice 30 for the fluid.

Reduction in the first pass-area reduces the fluid flow rate.

A subsequent movement of the shaft 42, in the first predefined direction, moves the first closing element 32 to seat it at the first seat 38 of the first orifice 30, as shown in FIG. 7a. At this, the first orifice 30 closes completely, offering a null first pass-area to the fluid, as shown in FIG. 7b. However, the second closing element 36 is still away from the smaller second orifice 34, as shown in FIG. 7a, thus, the second orifice 34 is fully open to offer the maximum second pass-area 48 to the fluid, as shown in FIG. 7b. With the first orifice 30 fully closed and the smaller second orifice 34 fully open, a substantially low fluid flow rate is possible to achieve.

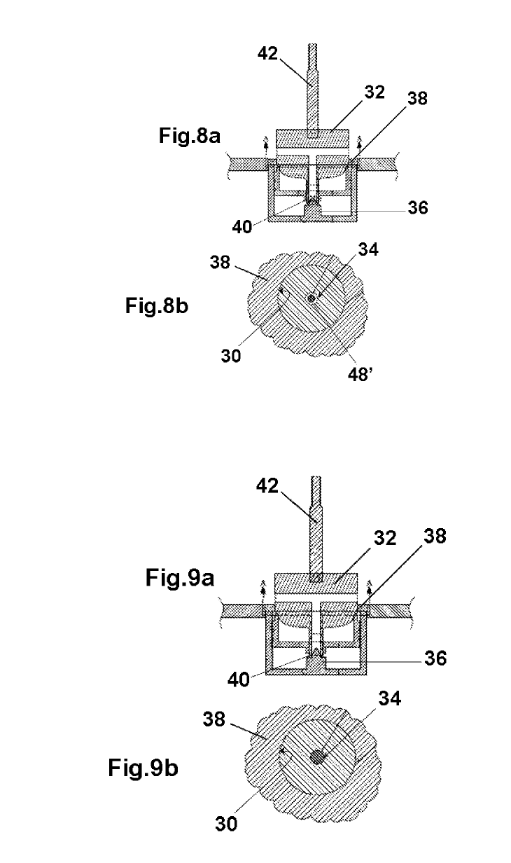

The control system 20 is configured in such a way that a subsequent movement of the shaft 42, in the first predefined direction, after the first closing element 32 is seated on the first orifice 30, moves the second orifice 34, which is part of the first closing element 32, towards the second closing element 36, as shown in FIG. 8a. This movement of the shaft 42 initially reduces the second pass-area of the second orifice 34 for the fluid from the maximum second pass-area 48 to a partial (or minimum) second pass-area 48′, as shown in FIG. 8b. This reduction in the second pass-area reduces the fluid flow rate to the minimum.

A larger orifice has a larger plug. The larger orifice and plug will undergo higher expansions and contractions. As a result of this and also for same percentage of machining tolerance there is a larger variation in size of the larger orifice and plug as compared to the smaller orifice and plug. This results in a larger gap between the larger plug and orifice than between the smaller plug and orifice. Further, it is commonly known that the clearance area is a multiple of clearance gap and perimeter of the plug or orifice. Thus, even for same clearance, larger plug or orifice will result in a larger clearance area. The smaller second orifice 34 has a small clearance that enables the control of very low flow rates near the closing stage of the control system 20. This elucidates that the minimum flow regulation capabilities of the fluid control system 20, according to the present subject matter, are much improved as compared to the conventional control system 2.

Further, a subsequent movement of the shaft 42, in the first predefined direction, moves the second orifice 34 to rest it at the second closing element 36, as shown in FIG. 9a. At this, the smaller second orifice 34 closes completely, offering a null second pass-area to the fluid, as shown in FIG. 9b, with the first orifice 30 already closed by the first closing element 32. For this position, the control system 20 is said to be in a closed state (or fully closed state) and the fluid flow rate is zero. Thus, during this closing movement of the shaft 42 in the first predefined direction, the fluid flow rate decreases depending on the decrease in the pass-areas of both the orifices 30 and 34.

From the closed state of the control system 20, the shaft 42 moves in a second predefined direction that first lifts the second seat 40 of the second orifice 34 off from the second closing element 36 without moving the first closing element 32 away from the first seat 38 of the first orifice 30. This movement initially increases the second pass-area of the second orifice 34 for the fluid before opening the second orifice 34 fully. A subsequent movement of the shaft 42, in the second predefined direction, lifts the first closing element 32 off from the first seat 38 of the first orifice 30 with the second closing element 36 already completely away from second orifice 34. This movement initially increases the first pass-area of the first orifice 30 for the fluid before opening the first orifice 30 fully. During this opening movement of the shaft 42 in the second predefined direction, the fluid flow rate increases depending on the increase in the pass-areas of both the orifices 30 and 34.

The above explanation illustrates that during the closing movement of the shaft 42 the first orifice 30 is closed before the smaller second orifice 34, and during the opening movement of the shaft 42 the smaller second orifice 34 is opened before the first orifice 30.

The fluid control system 20, according to the present subject matter, is advantageous that it has much improved minimum flow regulation capabilities at the time of opening a fully closed control system 20 and/or at the time of fully closing the control system 20.

Further, in the fluid control system 20, the first closing element 32 has a channel 62 for equalizing of fluid pressure at a first end 64 and a second end 66 of the first closing element 32. As shown, the first end 64 and the second end 66 are the bottom end and the top end of the first closing element 32, respectively. The channel 62 is understood to be a hollow passage, through which the fluid flowing through the system 20 flows to and from the first end 64 and the second end 66. In an implementation, the channel 62 is machined within the first closing element 32. The channel 62 in the first closing element 32 provides for equalization of fluid pressure at the first end 64 and the second end 66 across the first closing element 32, thus nullifying the fluid pressure forces on the first closing element 32 and substantially reducing the affects of fluid pressure variations on the force required to operate the shaft 42 and/or the first closing element 32 in the system 20.

In the implementation of the fluid control system 20 shown in FIG. 5, the valve casing 22 has a cover 68 connected through bolts or other such means. The cover 68 has a projected section 70 with closed peripheral boundary. The projected section 70 forms a hollow section that accommodates the first closing element 32. The hollow section is cylinder-like, which matches the periphery of the first closing element 32.

The projected section 70 of the cover 68 has a length more than the travel of the first closing element 32. The first closing element 32, fixedly coupled to the shaft 42, moves in the hollow section and, with the second end 66, forms a balancing chamber 72, as shown in FIG. 5. Further, a sealing ring 74 of a resilient material, for example rubber, is provided on the periphery, near the second end 66, of the first closing element 32. The sealing ring 74 facilitates a substantially leak-proof contact between an outer surface of the first closing element 32 and an inner surface of the projected section 70, throughout the travel of the first closing element 32.

The fluid, flowing in the fluid control system 20, passes from the first end 64, through the channel 62, to fill the balancing chamber 72. With the passing of the fluid in the balancing chamber 72, the fluid pressure near the second end 66 becomes substantially equal to the fluid pressure near the first end 64. With substantially equal fluid pressure on both the ends 64 and 66 of the first closing element 32, the fluid pressure forces on the first closing element 32 are balanced. This balancing of forces substantially eliminates the effects of the fluid pressure forces, caused by fluid pressure variations or pressure transients, on the force required to actuate the shaft 42 or operate the first closing element 32. Since only frictional forces are needed to be overcome, the amount of force required to operate or actuate substantially reduces. Thus, an actuator of a small size may be sufficed for the actuation of the shaft 42 and, particularly, for the operation of the first closing element 32.

Further, with the channel 62 in the first closing element 32 and the balancing chamber 72 in the system 20, undesirable movements of the first closing element 32 due to the fluid pressure variations or pressure transients are substantially eliminated, which, otherwise, may have caused an undesirable opening of the first orifice 30.

Further, in the control system 20, the surface of a portion of the first closing element 32, which moves into the first orifice 30, is contoured. This portion of the first closing element 32 is contoured in such a manner that the first pass-area gradually and uniformly reduces or increases throughout the movement of the portion of the first closing element 32 inside the first orifice 30.

Similarly, in the control system 20, the surface of a portion of the second closing element 36, which moves into the second orifice 34, is contoured. This portion of the second closing element 36 is contoured in such a manner that the second pass-area gradually and uniformly reduces or increases throughout the movement of the portion of the second closing element 36 inside the second orifice 34.

Further, in the control system 20, the stroke length of the first closing element 32 is substantially equal to the height of the portion of the first closing element 32, contoured and movable inside the first orifice 30. And, the stroke length of the second closing element 36 is substantially equal to the height of the portion of the second closing element 36, contoured and movable inside the second orifice 34. As mentioned earlier, the stroke length of the closing element is the distance travelled by the closing element for opening or closing the orifice and varying the pass-area. With this, the first pass-area and the second pass-area progressively changes throughout the entire stroke of the first closing element 32 and the second closing element 36, respectively. The first pass-area and the second pass-area are minimum and maximum at the two ends of the stroke of the respective closing elements 32 and 36.

Further structural features of the control system 20, as shown in FIG. 5, are described in the following. These following features may be part of the preferred embodiment of the control system, but the control system is not restricted only to this embodiment. The first orifice 30 with the first seat 38 is formed on a sliding element 50. The sliding element 50 slides in a cage-like structure 52 (or cage 52 hereinafter) having the second closing element 36 integrated with the cage 52. The sliding direction of the sliding element 50 is preferably along the direction of movement of the shaft 42. The sliding element 50 has an opening 54, into which a section of the first closing element 32 having the second orifice 34 slides when the first closing element 32 is positioned in the first orifice 30. Further, a spring 56, preferably a coil spring, is positioned between the sliding element 50 and the cage 52 that supports the sliding element 50 in the cage 52.

During the closing movement of the shaft 42, from the fully open state of the control valve 20, the first closing element 32 moves towards the first orifice 30 to reduce the first pass-area before seating the first closing element 32 at the first seat 38 of the first orifice 30 to close the first orifice 30. During the closing movement of the shaft 42, after the first orifice 30 is closed by the first closing element 32, the first closing element 32 pushes the sliding element 50 with the first orifice 30 in the cage 52 that compresses the spring 56. This movement moves the smaller second orifice 34 of the first closing element 32 towards the second closing element 36, which reduces the second pass-area of the second orifice 34 before closing the second orifice 34. Further, during the opening movement of the shaft 42, from the fully closed state of the control system 20, the first closing element 32 moves along with the shaft 42 and the spring 56, in the compressed state, pushes the sliding element 50 against the first closing element 32 to keep the first orifice 30 completely closed. Thus, this movement of the shaft 42 and in-turn of the first closing element 32 initially relatively moves the smaller second orifice 34 away from the second closing element 36 to open the second orifice 34. In the opening movement of the shaft 42, the spring 56 pushes the sliding element 50 till the sliding element 50 reaches a limit position at a check-nut 58, which is positioned in the control system 20. During the opening movement of the shaft 42, after the sliding element 50 has reached the limit position at the check-nut 58, the first closing element 32 is lifted off from the first seat 38 of the first orifice 30 to open the first orifice 30, with the smaller second orifice 34 already open.

In an embodiment, the first closing element 32 and the second closing element 36 may be a plug, a globe, a needle, a gate or a butterfly disc, capable of seating at the seats 38 and 42 to close the orifices 30 and 34, respectively.

In an embodiment, the surface profiles of the orifices 30 and 34 may be contoured in the direction of movement of the shaft 42 that enable gradual increase and/or decrease of the pass-areas of the orifices 30 and 34 upon movements of the first closing element 32 and the second closing element 36.

In an embodiment, the first orifice 30, the second orifice 34, the first closing element 32 and the second closing element 36 are configured symmetric about a common axis 60. This common axis 60 preferably lies along the longitudinal axis of the shaft 42.

Further, in an embodiment, the common axis 60 lies along the direction of movements of the shaft 42.

Movements of the shaft 42 are not restricted to axial (linear) movements, as described for the embodiment shown in FIG. 5. In an embodiment (not shown), the movements of the shaft 42 may be rotary movements, and the first closing element and the second closing element may rotationally close and open the first orifice and the second orifice, respectively. In this embodiment, the surface profiles of the closing elements and/or the orifices may be contoured that enable gradual increase and/or decrease of the pass-areas of the orifices upon movements of the closing elements.

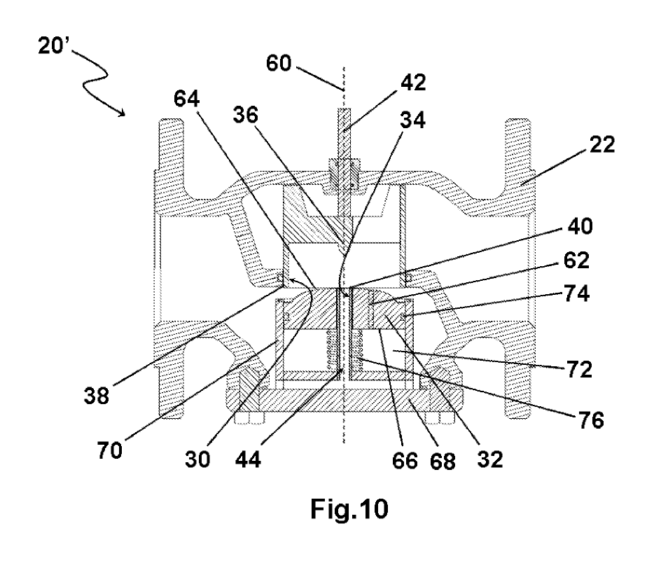

FIG. 10 illustrates a sectional view of a fluid control system 20′, according to another embodiment of the present subject matter. In FIG. 10, features, which are similar to the corresponding features of the fluid control system 20 of FIG. 5, are marked with same reference numerals for the sake of ease of the description. The fluid control system 20′ is in the form of the valve casing 22 that includes the first orifice 30 to provide the first pass-area to the fluid, the first closing element 32 to vary the first pass-area, the second orifice 34, configured in the first closing element 32, to provide the second pass-area to the fluid, and the second closing element 36 to vary the second pass-area. In the fluid control system, the second orifice 34 is smaller than the first orifice 30. Further, the first orifice 30 includes the first seat 38 for the first closing element 32 to rest and close the first orifice 30, and the second orifice 34 includes the second seat 40 for the second closing element 36 to rest and close the second orifice 34. Further, the first pass-area and the second pass-area are varied by the first closing element 32 and the second closing element 36 through movements of the actuating shaft 42 of the control system 20′. The movements of the shaft 42 relatively move the first orifice 30 and the first closing element 32 with respect to each other, and relatively move the second closing element 36 and the second orifice 34 with respect to each other.

The control system 20′ of FIG. 10 is structurally different from the control system 20 as shown in FIG. 5, however essential operation of closing the first orifice 30 before closing the smaller second orifice 34 and opening the smaller second orifice 34 before opening the first orifice 30 is same in the both the control systems 20 and 20′.

Further, in the fluid control system 20′, as shown in FIG. 10, the cover 68 has the projected section 70, which forms a hollow section, similar to the one shown in FIG. 5. The first closing element 32 moves in the hollow section within the projected section 70. The sealing ring 74 is provided on the first closing element 32 to maintain a closed contact between an outer surface of the first closing element 32 and an inner surface of the projected section 70. Further, a coil spring 76 is provided in the hollow section of the projected section 70, which supports the first closing element 32 therein. The coil spring 76, in its expanded state, holds the first closing element 32 against the first seat 38, while the first orifice 30 is closed.

Further, in the fluid control system 20′, the first closing element 32 has the channel 62 for equalizing of fluid pressure of the first end 64 and the second end 66 of the first closing element 32. As shown, the first end 64 and the second end 66 are the bottom end and the top end of the first closing element 32, respectively. The first closing element 32, with the second end 66, forms the balancing chamber 72. The fluid, flowing in the fluid control system 20′, passes from the first end 64, through the channel 62, to fill the balancing chamber 72. With the passing of the fluid in the balancing chamber 72, the fluid pressure near the second end 66 becomes substantially equal to the fluid pressure near the first end 64. With substantially equal fluid pressure on both the ends of the first closing element 32 and hence across the first closing element 32, the fluid pressure forces on the first closing element 32 are balanced.

With the balancing of the fluid pressure forces on the first closing element 32, the coil spring 76 has to overcome only the frictional forces, and not the forces due to fluid pressure variations in the system 20′. Also, the strength of the coil spring 76 required in the system 20′ becomes substantially independent of the fluid pressures in the system 20′. Thus, the coil spring 76 need not be of a high strength, and a substantially small spring may be used as the coil spring 76.

Also, the balancing of forces substantially eliminates the effects of the fluid pressure forces, caused by fluid pressure variations or pressure transients, on the first closing element 32. Thus, any undesirable movement, such as chattering or jumping, of the first closing element 32 due to the fluid pressure variations or pressure transients is substantially eliminated, as at no point of time the fluid pressure can overcome the spring pressure of the coil spring 76.

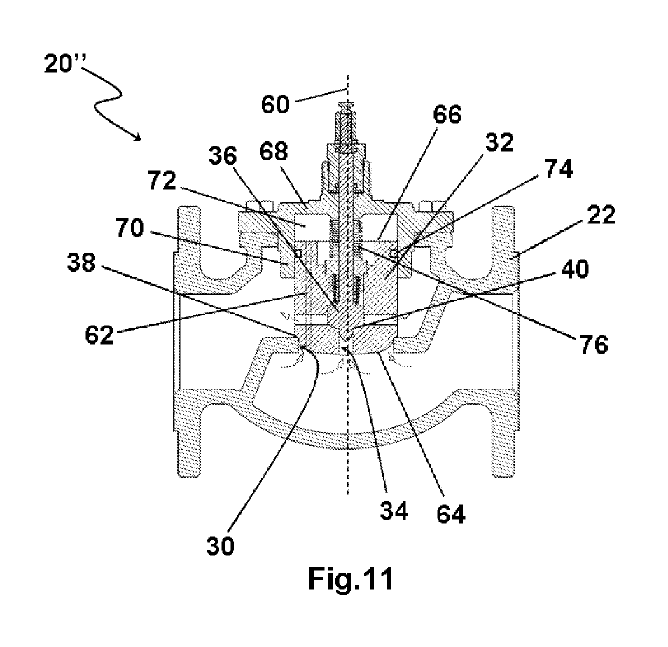

FIG. 11 illustrates a sectional view of a fluid control system 20″, according to another embodiment of the present subject matter. In FIG. 11, features, which are similar to the corresponding features of the fluid control system 20 of FIG. 5, are marked with same reference numerals for the sake of ease of the description. The fluid control system 20″ is in the form of the valve casing 22 that includes the first orifice 30 to provide the first pass-area to the fluid, the first closing element 32 to vary the first pass-area, the second orifice 34, configured in the first closing element 32, to provide the second pass-area to the fluid, and the second closing element 36 to vary the second pass-area. In the fluid control system, the second orifice 34 is smaller than the first orifice 30.

Further, the first orifice 30 includes the first seat 38 for the first closing element 32 to rest and close the first orifice 30, and the second orifice 34 includes the second seat 40 for the second closing element 36 to rest and close the second orifice 34. Further, the first pass-area and the second pass-area are varied by the first closing element 32 and the second closing element 36 through movements of the actuating shaft 42 of the control system 20″. The movements of the shaft 42 relatively move the first orifice 30 and the first closing element 32 with respect to each other, and relatively move the second closing element 36 and the second orifice 34 with respect to each other.

The control system 20″ of FIG. 11 is structurally different from the control system 20 as shown in FIG. 5, however essential operation of closing the first orifice 30 before closing the smaller second orifice 34 and opening the smaller second orifice 34 before opening the first orifice 30 is same in the both the control systems 20 and 20″.

Further, in the fluid control system 20″, as shown in FIG. 11, the cover 68 has the projected section 70, which forms a hollow section, similar to the one shown in FIG. 5. The first closing element 32 moves in the hollow section within the projected section 70. The sealing ring 74 is provided on the first closing element 32 to maintain a closed contact between an outer surface of the first closing element 32 and an inner surface of the projected section 70. Further, a coil spring 76 is provided in the hollow section of the projected section 70, which supports the first closing element 32 therein. The coil spring 76, in its expanded state, holds the first closing element 32 against the first seat 38, while the first orifice 30 is closed.

Further, in the fluid control system 20′, the first closing element 32 has the channel 62 for equalizing of fluid pressure of the first end 64 and the second end 66 of the first closing element 32. As shown, the first end 64 and the second end 66 are the bottom end and the top end of the first closing element 32, respectively. The first closing element 32, with the second end 66, forms the balancing chamber 72. The fluid, flowing in the fluid control system 20′, passes from the first end 64, through the channel 62, to fill the balancing chamber 72. With the passing of the fluid in the balancing chamber 72, the fluid pressure near the second end 66 becomes substantially equal to the fluid pressure near the first end 64. With substantially equal fluid pressure on both the ends of the first closing element 32 and hence across the first closing element 32, the fluid pressure forces on the first closing element 32 are balanced.

With the balancing of the fluid pressure forces on the first closing element 32, the coil spring 76 has to overcome only the frictional forces, and not the forces due to fluid pressure variations in the system 20′. Also, the strength of the coil spring 76 required in the system 20′ becomes substantially independent of the fluid pressures in the system 20′. Thus, the coil spring 76 need not be of a high strength, and a substantially small spring may be used as the coil spring 76.

Also, the balancing of forces substantially eliminates the effects of the fluid pressure forces, caused by fluid pressure variations or pressure transients, on the first closing element 32. Thus, any undesirable movement, such as chattering or jumping, of the first closing element 32 due to the fluid pressure variations or pressure transients is substantially eliminated, as at no point of time the fluid pressure can overcome the spring pressure of the coil spring 76.

In an embodiment, the control valve system 20, 20′, 20″ is made of cast iron, brass, stainless steel, other metals, polymer or composites.

Further, according to the present subject matter, the fluid can be selected from a group comprising, but not limiting to a liquid, a gas, steam and slurry.

The fluid control system 20, 20′, 20″, according to the present subject matter, including two orifices 30 and 34, one smaller than the other and working in parallel with each other, i.e. the bigger orifice closing first and opening last and the smaller orifice closing last and opening first, advantageously increases the rangeability and substantially improves the minimum flow regulation capabilities. With this fluid control system 20, 20′, 20″, a wider controllability range of fluid flow rates near high flow rates and close to substantially low flow rates is possible to achieve. Also, the construction and operation of the advantageous control system, according to the present subject matter, is simple and easy.

Further, as described earlier, for the sake of simplicity, in the specification, the fluid control system is described with two orifices and operating in parallel. However, the description can be extended to a fluid control system, according to another embodiment, configured with more than two orifices of different sizes and having the same working principle of orifices operating in parallel with respect to each other.

The fluid control system, in an embodiment, includes a plurality of orifices, and a plurality of closing elements, one each for each orifice, to vary the pass-area of the orifice. The plurality of orifices includes at least one orifice of different size than the other orifices. Each orifice provides a pass-area to the fluid. Each orifice includes a seat for the corresponding closing element to rest and close the orifice. The fluid control system further includes a single actuating shaft to control relative movements of the plurality of the closing elements and the orifices with respect to each other. The pass-area of each orifice is varied by the corresponding closing element through movements of the actuating shaft. By the movements of the actuating shaft a smallest orifice opens first and closes last and a biggest orifice closes first and opens last. All the orifices follow a sequence during opening and closing modes of the control system. Further, at least a biggest closing element includes a channel between a top end of the biggest closing element and a bottom end of the biggest closing element. The channel passes within the biggest closing element, from the top end to the bottom end, for equalizing of fluid pressure across the biggest closing element. The equalization of the fluid pressure across the biggest closing element substantially facilitates in keeping the force required to operate the biggest closing element as unchanged, irrespective to any fluid pressure variation or pressure transients in the fluid control system. The equalization also substantially eliminates any undesirable movement, such as chattering, of the biggest closing element due to the fluid pressure forces. Further, a balancing chamber is configured at, or in the proximity of, the top end of the biggest closing element. The fluid flowing in the fluid control system flows through the channel to and from the balancing chamber. With the filling of the fluid in the balancing chamber, the balancing chamber is maintained a fluid pressure substantially same as the fluid pressure in the system. Thus, the balancing chamber and the channel facilitate in equalizing the fluid pressure across the biggest closing element.

Other advantages of the inventive fluid control system will become better understood from the description and claims of an exemplary embodiment of such a unit.

The inventive fluid control system of the present subject matter is not restricted to the embodiments that are mentioned above in the description.

Although the subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter. It is therefore contemplated that such modifications can be made without departing from the spirit or scope of the present subject matter as defined.

I claim:

1. A fluid control system installed in a flow path of a fluid, the fluid control system comprising:
a first orifice to provide a first pass-area to the fluid;
a first closing element to vary the first pass-area;
a second orifice, smaller than the first orifice and configured in the first closing element, to provide a second pass-area to the fluid;
a second closing element to vary the second pass-area;
a single actuating shaft; and
a balancing chamber;
wherein the first closing element comprises a channel between bottom end of the first closing element and top end of the first closing element, and wherein the fluid flows through the channel to and from the balancing chamber for equalizing of fluid pressure across the first closing element, and wherein the first orifice comprises a first seat for the first closing element to rest and close the first orifice, and wherein the second orifice comprises a second seat for the second closing element to rest and close the second orifice, and wherein the first pass-area and the second pass-area are varied by the first closing element and the second closing element through movements of the single actuating shaft, and wherein the first closing element and the second closing element are contoured in the direction of movement of the actuating shaft to vary the first pass-area and the second pass-area.

2. The fluid control system as claimed in claim 1, wherein the first pass-area and the second pass-area are reduced and subsequently closed during a closing movement of the actuating shaft.

3. The fluid control system as claimed in claim 2, wherein in the closing movement the actuating shaft moves in a first predefined direction to reduce and close the first pass-area before reducing and closing the second pass-area.

4. The fluid control system as claimed in claim 3, wherein the actuating shaft moves in the first predefine direction to close the first orifice by relatively moving the first closing element and the first orifice towards each other and resting the first closing element at the first seat, before closing the second orifice by relatively moving the second closing element and the second orifice towards each other and resting the second closing element at the second seat.

5. The fluid control system as claimed in claim 1, wherein the first pass-area and the second pass-area are opened and subsequently increased during an opening movement of the actuating shaft.

6. The fluid control system as claimed in claim 5, wherein in the opening movement the actuating shaft moves in a second predefined direction to open and increase the second pass-area before opening and increasing the first pass-area.

7. The fluid control system as claimed in claim 6, wherein the actuating shaft moves in the second predefine direction to open the second orifice by relatively moving the second closing element and the second orifice away from each other, before opening the first orifice by relatively moving the first closing element and the first orifice away from each other.

8. The fluid control system as claimed in claim 1, wherein the actuating shaft is connected to the first closing element.

9. The fluid control system as claimed in claim 1, wherein the fluid flows through both the first orifice and the second orifice for achieving a substantially high flow rate, and wherein the fluid flows only through the second orifice for achieving a substantially low flow rate.

10. The fluid control system as claimed in claim 1, wherein the fluid control system is enclosed in a housing with a single inlet port and a single outlet port of the flow path.

11. The fluid control system as claimed in claim 1, wherein the first orifice and the second orifice are of a closed perimeter shape.

12. The fluid control system as claimed in claim 1, wherein the first orifice and the second orifice comprise surface profiles contoured in the direction of movement of the actuating shaft.
